(19) United States
(12) Patent Application Publication
(10) Pub. No.: US 2026/0371226 A1
(43) Pub. Date: Nov. 19, 2026

(54) SECURE BROADCAST INFORMATION FOR NON-PUBLIC NETWORKS (NPNs)

(71) Applicant: QUALCOMM Incorporated, San Diego, CA (US)

(72) Inventors: Brahmananda Reddy DEVIREDDY, Hyderabad (IN); Dhananjay Kumar PANDEY, Gopalganj (IN); Anirudha BEHURA, Hyderabad (IN); Anek Pal SINGH, Hyderabad (IN)

(21) Appl. No.: 19/212,451

(22) Filed: May 19, 2025

(51) Int. Cl. H04W 48/10; H04W 72/23

(52) U.S. Cl. CPC H04W 48/10; H04W 72/23

(57) ABSTRACT

Systems and techniques are described for wireless communications. For example, a computing device can receive, from a network device, a master information block (MIB). The computing device can determine, based on decoding the MIB, a cell type associated with the network device, wherein the cell type is a non-public network (NPN) cell or a non-NPN cell. In some cases, upon reading the MIB, the computing device can determine whether to decode information in a system information block type one (SIB1) in a secured manner based on decoded information in the MIB indicating the cell type, which can avoid unnecessary reading/decoding of information in the SIB1 from an unauthorized network and also to prevent unauthorized access.

### FIELD

The present disclosure generally relates to wireless communications. For example, aspects of the present disclosure relate to securing broadcast information for non-public networks (NPNs), such as for a sixth-generation (6G) mobile standard.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for wireless communications. In some aspects, an apparatus for wireless communications is provided. The apparatus includes at least one memory and at least one processor coupled to the at least one memory and configured to: receive, from a network device, a master information block (MIB); and determine, based on decoding the MIB, a cell type associated with the network device, wherein the cell type is a non-public network (NPN) cell or a non-NPN cell.

In some aspects, a method for wireless communications at a computing device is provided. The method includes: receiving, from a network device, a master information block (MIB); and determining, based on decoding the MIB, a cell type associated with the network device, wherein the cell type is a non-public network (NPN) cell or a non-NPN cell.

In some aspects, a non-transitory computer-readable medium is provided having stored thereon instructions that, when executed by at least one processor, cause the at least one processor to: receive, from a network device, a master information block (MIB); and determine, based on decoding the MIB, a cell type associated with the network device, wherein the cell type is a non-public network (NPN) cell or a non-NPN cell.

In some aspects, an apparatus for wireless communications is provided. The apparatus includes: means for receiving, from a network device, a master information block (MIB); and means for determining, based on decoding the MIB, a cell type associated with the network device, wherein the cell type is a non-public network (NPN) cell or a non-NPN cell.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a smart or connected device (e.g., an Internet-of-Things (IoT) device), a wearable device, a personal computer, a laptop computer, a video server, a television (e.g., a network-connected television), a vehicle (or a computing device, system, or component of a vehicle), a robotics device or system, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with some aspects of the disclosure.

FIG. 2 is a diagram illustrating a design of a base station and a user equipment (UE) device that enable transmission and processing of signals exchanged between the UE and the base station, in accordance with some aspects of the disclosure.

FIG. 3 is a diagram illustrating an example of a disaggregated base station, in accordance with some aspects of the disclosure.

FIG. 4 is a block diagram illustrating components of a user equipment, in accordance with some aspects of the disclosure.

FIG. 5 is a diagram illustrating an example of a computing device performing a cell search, in accordance with some aspects of the disclosure.

FIG. 6 is a diagram illustrating an example of mapping system information to different channels, in accordance with some aspects of the disclosure.

FIG. 7 is a flow diagram illustrating an example of a process for wireless communications, in accordance with some aspects of the disclosure.

FIG. 8 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a third Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. A computing device (e.g., a UE, wireless device, mobile device, etc.) can be configured to access a wireless network (e.g., wireless system) to communicate with other devices. In some cases, a base station may be connected to a set of wireless devices (e.g., computing devices, such as UEs) to allow the wireless devices to access services of the wireless network. In some cases, the base station may transmit control messages (e.g., radio resource control (RRC) messages) to the connected wireless devices, for example, to reconfigure multiple wireless devices of the set of wireless devices. An RRC message can indicate the selective transmission (by the base station) of a few synchronization signal blocks (SSBs). A synchronization signal block (SSB) includes a primary synchronization signal (PSS), a secondary synchronization signal (SSS), and a physical broadcast channel (PBCH).

A wireless device can perform a cell search for accessing a cell (e.g., a wireless network). A cell search is a procedure where the wireless device can acquire time and frequency synchronization for a cell (e.g., associated with a base station), and can decode the physical cell identification (PID) of that cell. The cell search involves decoding the PSS and the SSS to obtain the PCI of the cell. Cell search information (e.g., frequency, cell ID, random access channel (RACH) parameters, cell access related parameters, allowed public land mobile networks (PLMNs), Common Channel Information, etc.) is provided (e.g., by the base station or other network entity) in an RRC reconfiguration message, such as a system information block type one (SIB1) message or RRC reconfiguration message. The wireless device can attempt to use the RACH to access the cell.

For example, during operation of a cell search by a computing device, the computing device can tune its antenna to a specific frequency (e.g., for receiving signals) for a cell search. The computing device can then attempt to detect the PSS and SSS signals (of the SSB) to acquire frequency and time synchronization for the cell. The computing device can then decode the PBCH (of the SSB) MIB content information.

The computing device can, based on the MIB content information, decode the physical downlink control channel (PDCCH) and the physical downlink shared channel (PDSCH) for obtaining the RMSI (e.g., which includes the SIB1) and the OSI (e.g., which includes the system information block type two (SIB2) to the system information block type nine (SIB9)). In order for a computing device to be able to decode the SIB1, all the required information is obtained from the MIB. The MIB provides the computing device with parameters (e.g., a CORESET #0 configuration) required to acquire the SIB1, more specifically, information required for monitoring of the PDCCH for scheduling the PDSCH that carries the SIB1.

The computing device 510 can then read the RMSI (from the SIB1), and can then decode the public land mobile network (PLMN) ID, cell selection parameters, and RACH parameters. The computing device 510 can then attempt uplink synchronization based on the RACH procedure for accessing the cell.

Zero trust architectures have been suggested as a main design requirement for 6G. As such, there is a need to introduce security at each level (e.g., for a computing device to access a cell), wherever legacy technologies are not applying security. Hence, the security to the broadcast information (e.g., the SIB1) will also be required for 6G.

As mentioned, based on information (e.g., a CORESET #0 configuration) in the MIB, a computing device (e.g., UE) can attempt to decode the SIB1. After a successful decoding of the SIB1, the computing device can decode the cell selection criteria (e.g., PLMN validation, etc.) and other cell selection criteria.

In legacy technologies, any computing device (e.g., UE) is able to decode the MIB and SIB1 from any network (e.g., any cell). However, after the decoding of the SIB1, based on the PLMN validation and/or other cell selection criteria, the computing device may fail to be able to access the network (e.g., the computing device is not authorized to access the network). But, successful decoding of the SIB1 itself provides lot of information about the basic network settings to the computing device, which may be a rouge UE or an unauthorized UE.

The network (e.g., cell) may be a non-public network (NPN) cell. An NPN cell is a cell that is only available for normal service for subscribers of the NPN (e.g., NPN computing devices, such as NPN UEs). As such, a non-NPN computing device (e.g., a non-NPN UE) is not subscribed to the network and, thus, is not authorized to have access to the NPN cell. In legacy technologies, an NPN-capable computing device (e.g., an NPN-capable UE, which may or may not be subscribed to the NPN) can only determine that the cell is a NPN-only cell by decoding the SIB1 (e.g., by detecting information elements, including cellReservedForOtherUse and npn-IdentityInfoList, within the decoded SIB1). An NPN-capable computing device that is not subscribed to the NPN (e.g., a non-NPN computing device) would waste computing resources by needing to decode the SIB1 to determine that the type of the cell is an NPN cell.

As such, improved systems and techniques to secure broadcast information for NPNs can be beneficial.

In one or more aspects of the present disclosure, systems, apparatuses, methods (also referred to as processes), and computer-readable media (collectively referred to herein as “systems and techniques”) are described herein that provide solutions to secure broadcast information for NPNs, such as for 6G.

Various aspects relate generally to wireless communications. Some aspects more specifically relate to systems and techniques that provide solutions that address issues specific to NPNs, such as where an NPN-capable UE (which is not authorized to access the NPN cell) attempts to read the SIB1 (or other broadcast information) transmitted from the NPN cell and where a non-NPN UE unnecessarily reads the SIB1 of an NPN cell. The systems and techniques provide solutions to secure the SIB1 (or other broadcast information) of the NPN network (e.g., NPN cell) that, currently in legacy technologies, can be read by unauthorized UEs.

In one or more examples, the systems and techniques prevent an unnecessary read of an NPN SIB1 by other UEs (e.g., non-NPN UEs). For instance, in some aspects, the systems and techniques provide that that cell type (e.g., an NPN-cell or non-NPN cell) is broadcast within the MIB. In one or more examples, for added security, the systems and techniques can scramble the SIB1 (e.g., for coding of the SIB1) with the non-public network identification (NPN ID) associated with an NPN UE.

In one or more aspects, during operation of a method for wireless communications at a computing device (e.g., a UE), the computing device can receive, from a network device, a MIB. The computing device can determine, based on decoding the MIB, a cell type associated with the network device. In some examples, the cell type can be an NPN cell or a non-NPN cell.

In one or more examples, the computing device can receive, from the network device, a system information block type one (SIB1) (also referred to as a SIB1 message). In some examples, the SIB1 can be received via a physical downlink shared channel (PDSCH) transmitted from the network device.

In some cases, upon reading the MIB, the computing device can determine whether to decode the SIB1 in a secure manner, which can avoid the computing device from having to read certain information in the SIB1 (e.g., Cell Access information in the SIB1, such as CellAccessRelatedInfo), such as if the computing device is an NPN-capable computing device that is not subscribed to the NPN (e.g., avoid unnecessary reading/decoding of information in the SIB1 from an unauthorized network and also to prevent unauthorized access).

For instance, in some examples, the computing device can decode the SIB1. In one or more examples, decoding the SIB1 can include, based on the cell type being an NPN cell and the computing device being an NPN user equipment (UE), descrambling the SIB1 based on a system information-radio network temporary identifier (SI-RNTI) and a public network integrated NPN (PNI-NPN) identification, or based on the SI-RNTI and a standalone non-public network (SNPN) identification. In some examples, a non-public network identification (NPN ID) associated with the computing device can include the PNI-NPN identification and the SNPN identification. In one or more examples, a subscriber identity module (SIM) of the computing device can include the NPN ID.

In one or more examples, decoding the SIB1 can include, based on the cell type being a non-NPN cell, descrambling the SIB1 based on an SI-RNTI. In some examples, the computing device may not decode, based on the cell type being an NPN cell and based on the computing device being a non-NPN UE, the SIB1. In one or more examples, the MIB can be received via a physical broadcast channel (PBCH) transmitted from the network device. In some examples, the computing device can be UE. In one or more examples, the network device can be a base station.

Particular aspects of the subject matter described in this disclosure can be implemented to realize one or more of the following potential advantages. For example, the systems and techniques can provide the benefit of providing extra layers of security for the SIB1 of an NPN network that do not allow for unauthorized or rogue computing devices to be able to read the SIB1.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

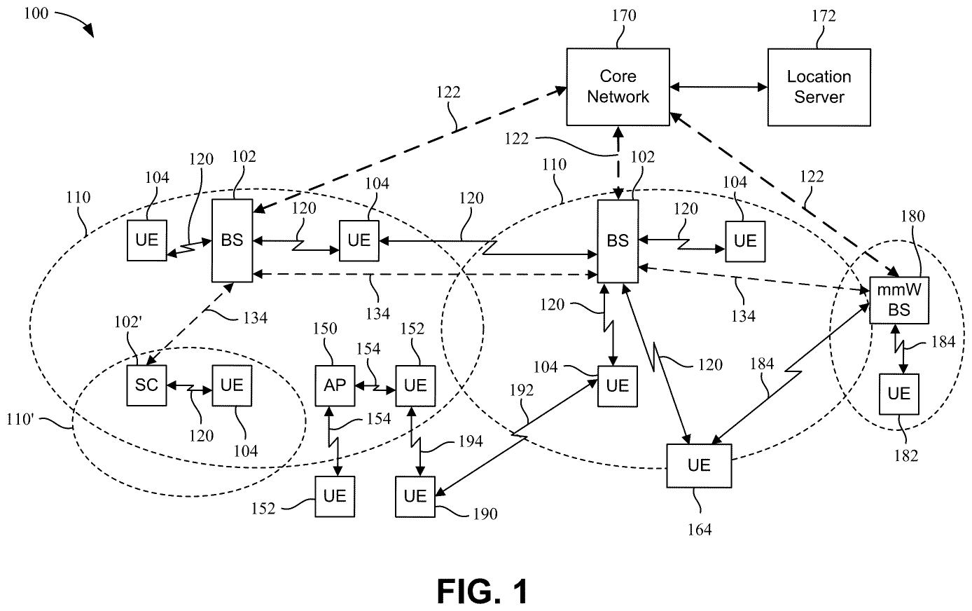

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes” or “network devices”. One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. The PCI may be a unique identifier for a cell indicated as a part of cell selection. The VCI may be an identifier for a virtual cell that maybe defined for a user based on a set of physical cells. The CGI may be a globally unique identifier representing a cell in a wireless network. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

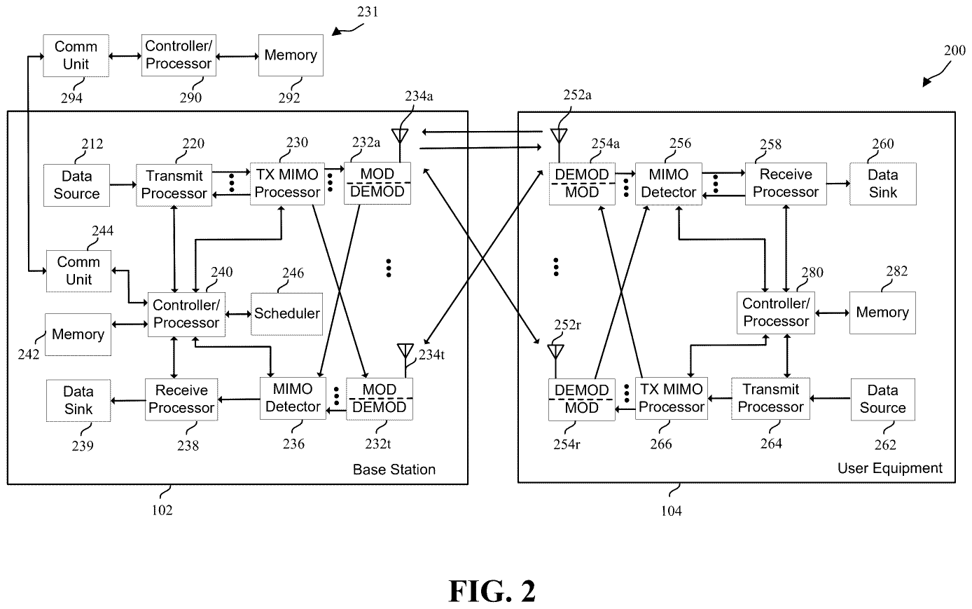

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU (e.g., centralized wireless node) may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

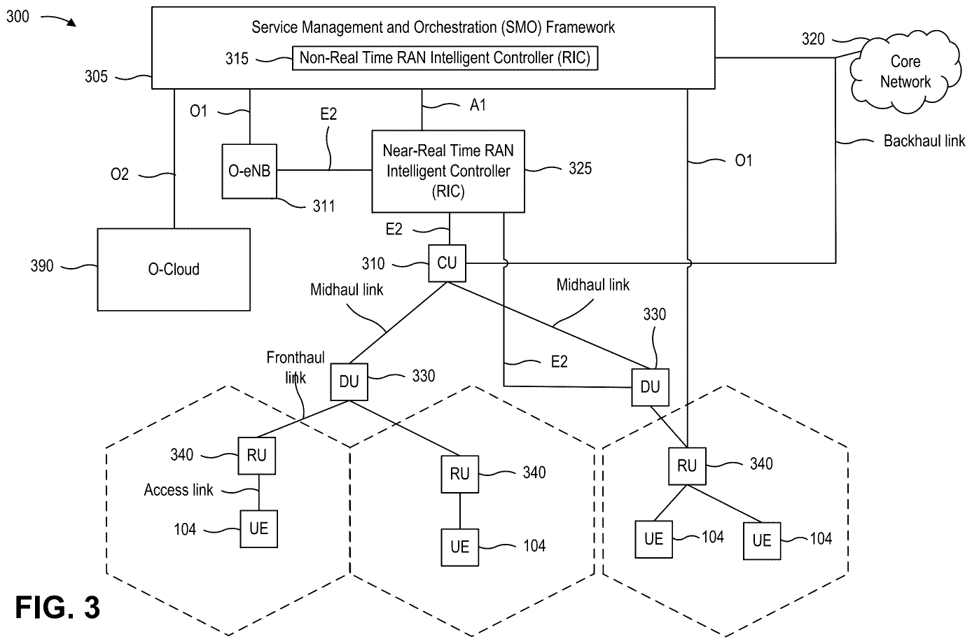

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

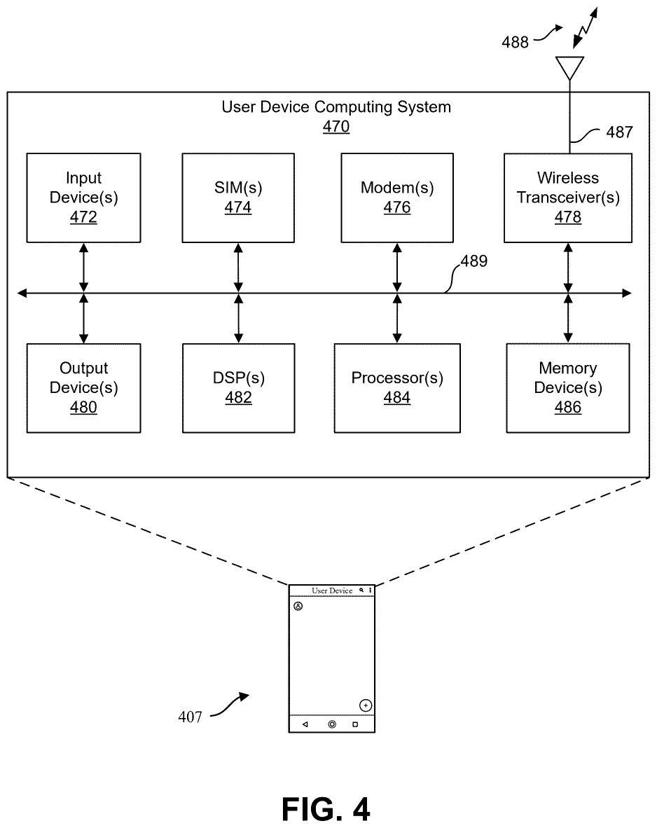

FIG. 4 illustrates an example of a computing system 470 of a wireless device 407. The wireless device 407 may include a client device such as a UE (e.g., UE 104, WLAN STAs 152, UE 190) or other type of device (e.g., a station (STA) configured to communication using a Wi-Fi interface) that may be used by an end-user. For example, the wireless device 407 may include a mobile phone, router, tablet computer, laptop computer, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

In one or more aspects, a base station (either disaggregated or aggregated) may be connected to a set of wireless devices (e.g., computing devices, such as UEs) to allow the wireless devices to access services of the wireless network. In some cases, the base station may transmit control messages (e.g., radio resource control (RRC) messages) to the connected wireless devices, for example, to reconfigure multiple wireless devices of the set of wireless devices.

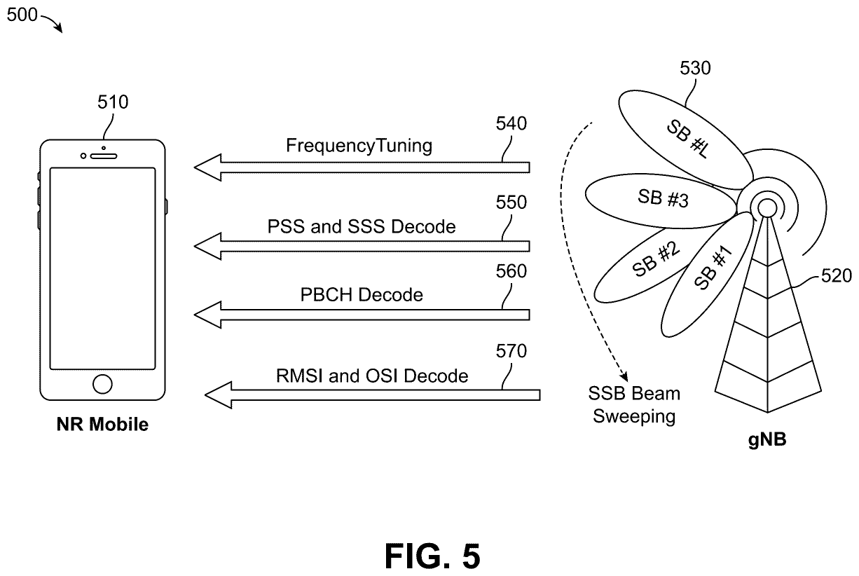

For example, the base station may transmit messages for reconfiguring multiple wireless devices using a message (e.g., an RRC message) addressed to multiple wireless devices. An RRC message can indicate the selective transmission (by the base station) of a few synchronization signal blocks (SSBs), and can inform the wireless devices of which SSBs are being transmitted and which are not. A synchronization signal block (SSB) includes a primary synchronization signal (PSS), a secondary synchronization signal (SSS), and a physical broadcast channel (PBCH). SSBs are transmitted (by the base station) in a batch by forming an synchronization signal (SS) burst (e.g., including one SSB per beam) that is used during beam sweeping by changing the beam direction for each SSB transmission. For example, as shown in FIG. 5, the SS burst can include a plurality of antenna beams 530 (e.g., SB #1, SB #2, SB #3, . . . SB #L) radiating in different directions. The beam sweeping mechanism can be used by wireless device to measure and identify the best beam for the wireless device to use for the cell.

In one or more aspects, a wireless device can perform a cell search, which is a procedure where the wireless device can acquire time and frequency synchronization for a cell (e.g., associated with a base station), and can decode the cell identification (ID) of that cell. The cell search concept involves decoding the PSS and the SSS to obtain the physical cell ID (PCI) of the cell. Cell search information (e.g., frequency, cell ID, random access channel (RACH) parameters, cell access related parameters, allowed public land mobile networks (PLMNs), Common Channel Information, etc.) is provided (e.g., by the base station or other network entity) in an RRC reconfiguration message, such as a system information block type one (SIB1) message or RRC reconfiguration message. The wireless device can attempt to use the RACH to access the cell.

FIG. 5 shows an example of a wireless device (e.g., a computing device) performing a cell search for accessing a cell. In particular, FIG. 5 is a diagram illustrating an example 500 of a computing device 510 performing a cell search, in accordance with some aspects of the disclosure. In FIG. 5, the computing device 510 and a base station 520 (e.g., a gNB) associated with a cell are shown.

In one or more examples, during operation of a cell search procedure, a computing device 510 (e.g., a wireless device, such as a UE) can tune (e.g., perform frequency tuning 540) its antenna to a specific frequency (e.g., for receiving signals) for a cell search. For example, the computing device 510 can scan a frequency band on a synchronization raster based on which frequency band the computing device 510 is performing the cell search on (e.g., which is defined by 3GPP 38.104, Section 5.4.3.3) to tune to the specific frequency. The synchronization raster indicates the frequency positions of the SSB that can be used by the computing device 510 for system acquisition when explicit signaling of the SSB position is not present. The synchronization raster and the subcarrier spacing of the SSB depends on each frequency band.

After the computing device 510 has tuned to the specific frequency, the computing device 510 can then attempt to detect the PSS and SSS signals (of the SSB) to acquire frequency and time synchronization for the cell. For example, the computing device 510 can decode (e.g., PSS and SSS decode 550) the PSS and SSS signals to obtain the physical cell identification (PCI) of the cell and the PBCH demodulation reference signal (DMRS), located on the synchronization raster. The PSS, SSS, and PBCH are transmitted in the SSB. For example, the SSB includes four symbols, which include the one-symbol PSS, the one-symbol SSS, and the two-symbol PBCH. The time synchronization (e.g., in terms of symbol time and slot time) and the frequency synchronization can be realized by the computing device 510 via the PSS and SSS. As such, after the computing device 510 detects the PSS and SSS signals, the computing device 510 can obtain knowledge (based on the PSS and SSS signals) regarding the synchronization and PCI for the cell.

After the computing device 510 obtains knowledge regarding the synchronization and the PCI for the cell, the computing device 510 can then decode the PBCH (of the SSB). For example, the computing device 510 can select the best antenna beam 530 (e.g., SB #1, SB #2, SB #3, . . . SB #L) to use, and can then decode (e.g., PBCH decode 560) the PBCH master information block (MIB) content information, which can include the system frame number (SFN), SSB index, raster offset, default downlink (DL) numerology, minimum system information (RMSI) configuration, DMRS location, and cell barring information.

After the computing device 510 has decoded the PBCH, the computing device 510 can attempt to decode (e.g., remaining minimum system information (RMSI) and other system information (OSI) decode 570) the physical downlink control channel (PDCCH) and the physical downlink shared channel (PDSCH) for obtaining the RMSI (e.g., which includes the system information block type one (SIB1)) and the OSI (e.g., which includes the system information block type two (SIB2) to the system information block type nine (SIB9)). For example, if computing device 510 is not barred from accessing the cell, computing device 510 can attempt to decode subsequent PDCCHs to obtain the frequency location of the PDSCH resources to obtain the SIB1 information. The configuration of the PDCCH for the RMSI is provided by the PBCH. The COntrol REsource SET (CORSET) configuration for the RMSI is associated with a SSB in a SSB burst set. A one-bit information field in the PBCH can indicate the subcarrier spacing (SCS) of the RMSI, as well as OSI and other messages in random access procedures for obtaining initial access.

The PDSCH carrying the SIB1 is scrambled using the system information-radio network temporary identifier (SI-RNTI), which has a fixed value of 0xFFFF (e.g., 65535). The computing device 510 can decode the PDCCH to find the downlink control information (DCI) messages that are scrambled with the SI-RNTI. The DCI messages provide the necessary information for the computing device 510 to be able to decode the PDSCH and retrieve the SIB1.

The computing device 510 can read the RMSI (from the SIB1), and can then decode the public land mobile network (PLMN) ID, cell selection parameters, and RACH parameters. If the PLMN ID of the cell network matches with a PLMN ID in a PLMN ID availability listing for the computing device 510, then the computing device 510 can attempt uplink synchronization based on the RACH procedure for accessing the cell.

In one or more aspects, system information (SI) is downlink broadcast information transmitted periodically by a base station. The SI is important information for a computing device (e.g., a wireless device, such as a mobile device) to connect to a base station (e.g., gNB) associated with a cell. The computing device can read the SI for cell selection and re-selection when the computing device is in RRC IDLE mode. The SI provides necessary information to access the cell network, such as system frame number, system bandwidth, PLMN, and cell selection and re-selection thresholds.

In one or more examples, the SI includes three categories, which include minimum system information (MSI), RMSI, and OSI. The MSI carries basic information required for initial access by a computing device and for acquiring any other SI. The MSI includes the MIB and the SIB1. For a computing device to be allowed to access a cell, the computing device must have acquired the contents of the MSI from that cell.

As the MSI includes both the MIB and the SIB1, the RMSI includes only the SIB1. The SIB1 carries the information (e.g., random access parameters) required for the computing device (e.g., UE) to access the cell. The SIB1 also includes information regarding the availability and scheduling of other SIBs (e.g., the mapping of SIBs to SI messages, periodicity, SI-window size etc.). The SIB1 can also indicate whether one or more SIBs are only provided on-demand, in which case, the SIB1 may also provide the PRACH configuration needed by the computing to request for the required SI. The SIB1 also contains RRC information that is common for all computing devices and cell barring information applied to the unified access control. The SIB1 is a cell-specific SIB.

The SIB2 includes cell re-selection information, mainly related to the serving cell. The SIB3 includes information about the serving cell frequency and intra-frequency neighboring cells relevant for cell re-selection (e.g., including cell re-selection parameters common for a frequency as well as cell specific re-selection parameters). The SIB4 includes information about other NR frequencies and inter-frequency neighboring cells relevant for cell re-selection (e.g., including cell re-selection parameters common for a frequency as well as cell specific re-selection parameters). The SIB5 includes information about evolved-universal terrestrial radio access (E-UTRA) frequencies and E-UTRA neighboring cells relevant for cell re-selection (e.g., including cell re-selection parameters common for a frequency as well as cell specific re-selection parameters). The SIB6 includes an earthquake and tsunami warning system (ETWS) primary notification. The SIB7 includes a ETWS secondary notification. The SIB8 includes a commercial mobile alert system (CMAS) warning notification. The SIB9 includes information related to GPS time and coordinated universal time (UTC).

In order for a computing device to be able to decode the SIB1, all the required information is obtained from the MIB. The MIB provides the computing device with parameters (e.g., a CORESET #0 configuration) required to acquire the SIB1, more specifically, information required for monitoring of the PDCCH for scheduling the PDSCH that carries the SIB1.

The MIB information is transmitted via the broadcast channel (BCH) and the PBCH. The SIBs (e.g., SIB1 to SIB9) are transmitted via the downlink shared channel (DL-SCH) and the PDSCH.

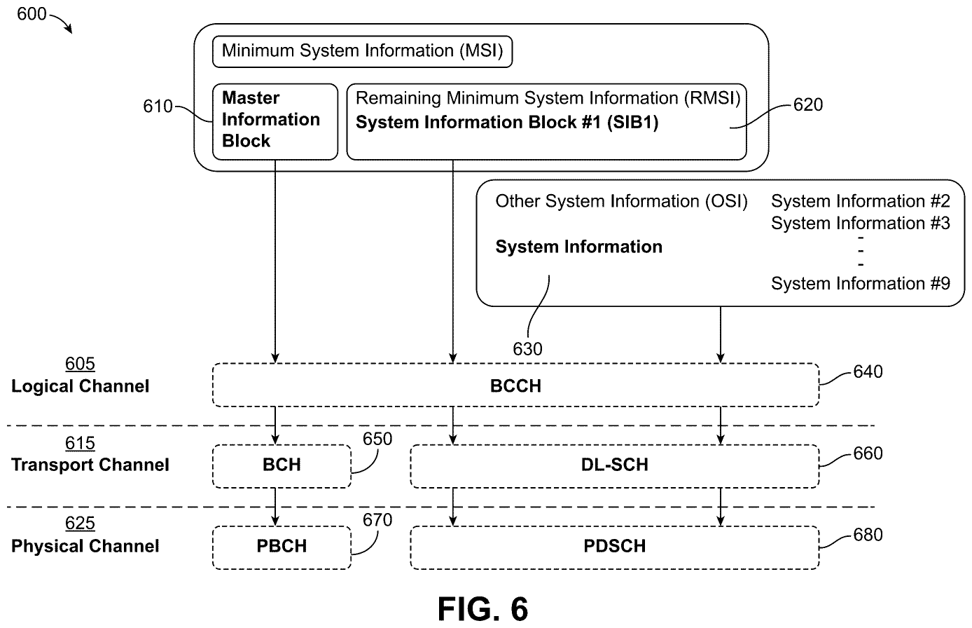

FIG. 6 shows an example mapping of the SI to different channels. In particular, FIG. 6 is a diagram illustrating an example 600 of mapping SI to different channels. As shown in FIG. 6, the MSI includes both the MIB 610 and the SIB1 620, the RMSI includes only the SIB1 620, and the OSI includes system information 630 including SIB2 to SIB9 (e.g., system information #2 to system information #9).

The MIB 610 and the SIB1 610 are each transmitted within their own associated RRC Message (e.g., which is “MasterInformationBlock” and “SystemInformationBlock1”, respectively). The SIB2 to SIB9 are wrapped within a generic RRC message (e.g., “SystemInformation”). The MSI is broadcast periodically, while other system information may either be broadcast, or provisioned in a dedicated manner, either triggered by the network or upon request from the computing device (e.g., UE).

The MIB 610 is transmitted over the broadcast control channel (BCCH) 640 logical channel 605, the BCH 650 transport channel 615, and the PBCH 670 physical channel 625. The SIB1 620 is transmitted over the BCCH 640 logical channel 605, the DL-SCH 660 transport channel 615, and the PDSCH 680 physical channel 625. The system information 630 (e.g., SIB2 to SIB9) is transmitted over the BCCH 640 logical channel 605, the DL-SCH 660 transport channel 615, and the PDSCH 680 physical channel 625.

As previously mentioned, zero trust architectures have been suggested as a major design requirement for 6G and, hence, there is a need to introduce security at each level (e.g., for a computing device to access a cell), wherever legacy technologies are not applying security. As such, the security to broadcast information (e.g., the SIB1) will be required for 6G.

In legacy technologies, any computing device is able to decode the MIB and SIB1 from any network (e.g., any cell). After decoding the SIB1, based on the PLMN validation and/or other cell selection criteria, the computing device may fail to access the network (e.g., the computing device is not authorized to access the network). However, successful decoding of the SIB1 itself provides lot of information about the basic network settings to the computing device (e.g., which may be a rouge or unauthorized to access the network).

The network (e.g., cell) can be a non-public network (NPN) cell, which is a cell that is only available for normal service for subscribers of the NPN (e.g., NPN computing devices). In legacy technologies, an NPN-capable computing device (e.g., which may or may not be subscribed to the NPN) may only determine that the cell is a NPN-only cell by decoding the SIB1 (e.g., by detecting information elements, including cellReservedForOtherUse and npn-IdentityInfoList, within the decoded SIB1). For instance, an NPN-capable UE may determine that a cell is an NPN-only cell by detecting that the cellReservedForOtherUse information element (IE) is set to true while the npn-IdentityInfoList IE is present in CellAccessRelatedInfo under the SIB1. An NPN-capable computing device that is not subscribed to the NPN (e.g., a non-NPN computing device) is wasting computing resources by having to decode the SIB1 in order to determine the cell type is an NPN cell. Therefore, improved systems and techniques to secure broadcast information for NPNs can be beneficial.

In one or more aspects, the systems and techniques provide solutions to secure broadcast information for NPNs, such as for 6G. In one or more examples, the systems and techniques provide solutions that address the unnecessary read, by a non-NPN UE (e.g., a legacy, public UE), of the SIB1 of an NPN cell. For example, the systems and techniques provide that cell type (e.g., an NPN-cell or non-NPN cell) is broadcast within the MIB. In one or more examples, the systems and techniques provide solutions that address an unauthorized read, by any NPN-capable UE (e.g., a UE from another closed subscriber group (CSG)), of the SIB1 of an NPN-only cell. For example, the systems and techniques provide, for an added security, to scramble the SIB1 (e.g., for coding of the SIB1) with the non-public network identification (NPN ID) associated with an NPN UE.

In one or more aspects, to achieve a zero trust architecture (e.g., for 6G), security at the broadcast signal (e.g., the SIB1) is important for private networks. In one or more examples, the MIB can indicate more information to the computing device (e.g., UE). For examples, the cell type (e.g., whether the cell is an NPN cell or a non-NPN cell) can be indicated within the MIB. By such an indication within the MIB, after decoding the MIB, a non-NPN computing device (e.g., non-NPN UE) can simply ignore (e.g., not decode) the SIB1 received from the NPN cell. By such an indication within the MIB, after decoding the MIB, an NPN-capable computing device (e.g., a computing device that is not registered with current NPN) can ignore reading (e.g., not decode) the SIB1.

As mentioned, in legacy technologies, the cell type is indicated by the SIB1 (e.g., cellReservedForOtherUse and npn-IdentityInfoList in the SIB1). In legacy operations (e.g., for a cell search), a non-NPN capable UE must read the SIB1 even in poor coverage scenarios in order to obtain the cell type information, which can require an substantial decoding effort for the decoding of the SIB1.

In one or more examples, the MIB can be transmitted, from a network device (e.g., a base station, such as a gNB) to a computing device (e.g., UE), via a physical broadcast channel (PBCH). The computing device can receive, from the network device via the PBCH, the MIB. The computing device can determine, based on decoding the MIB, the cell type associated with the network device. In some examples, the cell type can be an NPN cell or a non-NPN cell. In one or more examples, the computing device may ignore (e.g., not decode), based on the cell type being an NPN cell and based on the computing device being a non-NPN UE, the SIB1.

In some aspects, the PDSCH coding of the SIB1 is scrambled with the SI-RNTI (e.g., 65535) and at least a portion of the NPN ID. In one or more examples, the NPN ID is stored within the subscriber identity module (SIM), for example a universal SIM (USIM), of the computing device (e.g., a UE, such as a mobile phone). When the cell type is an NPN cell (e.g., as indicated by the MIB), the computing device can utilize at least a portion of the NPN ID (e.g., stored in the SIM) along with the SI-RNTI for descrambling the SIB1 to decode the SIB1.

In one or more examples, the SIB1 can be transmitted, from a network device (e.g., a base station, for example a gNB) to a computing device (e.g., UE), via a physical downlink shared channel (PDSCH). The computing device can receive, from the network device via the PDSCH, the SIB1. In one or more examples, the NPN ID includes a public network integrated NPN (PNI-NPN) identification (e.g., which includes a PLMN identity and a closed access group (CAG) identity) and a standalone non-public network (SNPN) identification (e.g., which includes a PLMN identity and a forty-four bit network identifier (NID)).

In some examples (e.g., when the cell type is an NPN cell), the SIB1 can be coded by scrambling the SIB1 with the SI-RNTI along with a portion of the NPN ID (e.g., the PNI-NPN identification or the SNPN identification). In one or more examples, the computing device can decode the SIB1. Decoding (by the computing device) the SIB1 can include, based on the cell type being an NPN cell and the computing device being an NPN UE, descrambling the SIB1 based on the SI-RNTI and the PNI-NPN identification, or based on the SI-RNTI and the SNPN identification.

By such a scrambling using the NPN ID, only a computing device that has configured to access the NPN network can be able to decode the SIB1 of the NPN cell. As such, this scrambling avoids a rogue or unauthorized computing device to be able to access the basic network information of an NPN cell. When a non-NPN UE (e.g., a legacy, public UE) is notified of the cell type of an NPN cell by the MIB, the non-NPN UE can save its resources (e.g., time and power) by not reading the SIB1 of an NPN-only.

However, in some examples (e.g., when the cell type is a non-NPN cell), the SIB1 can be coded by scrambling the SIB1 with the SI-RNTI. Decoding (by the computing device) the SIB1 can include, based on the cell type being a non-NPN cell (e.g., a public cell) and based on the computing device being either an NPN UE or a non-NPN UE, descrambling the SIB1 based on the SI-RNTI.

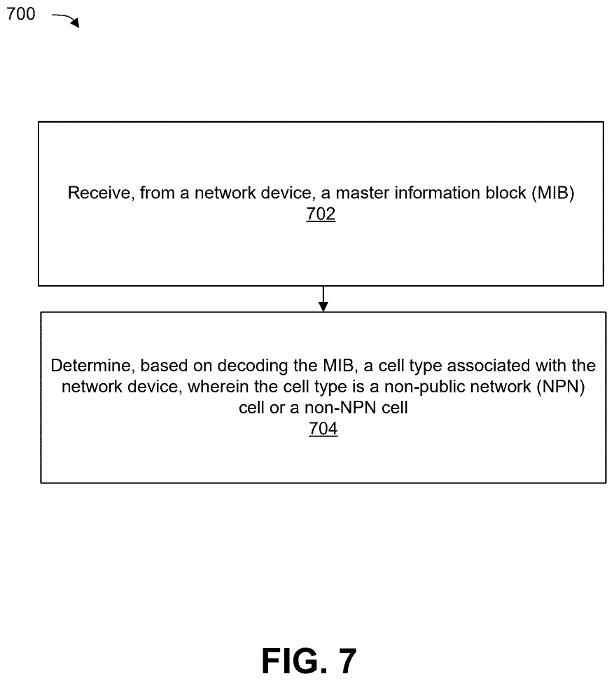

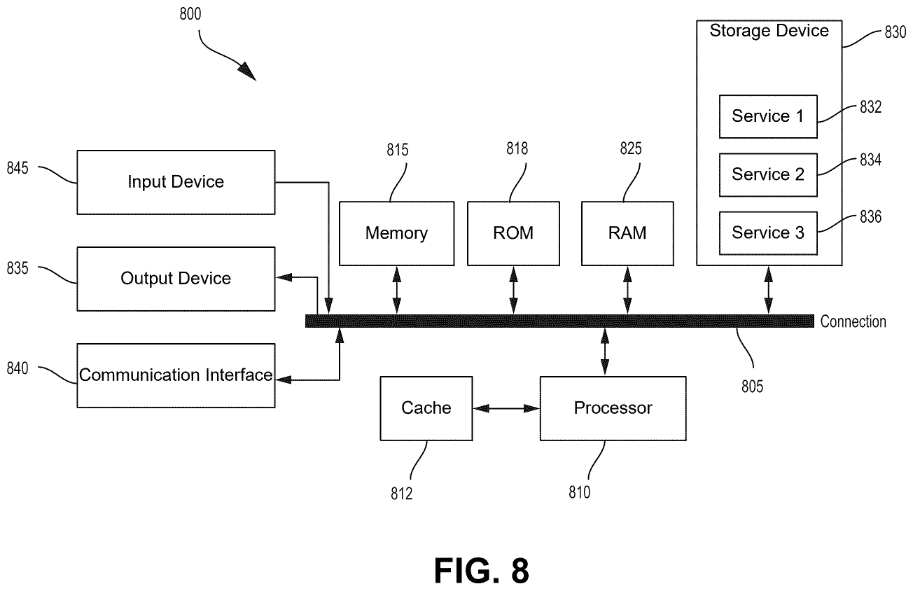

FIG. 7 is a flow chart illustrating an example of a process 700 for wireless communications. The process 700 can be performed by a computing device (e.g., a UE, a computing device or computing system 800 of FIG. 8) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 700 may be implemented as software components that are executed and run on one or more processors (e.g., processor 810 of FIG. 8, or other processor(s)). Further, the transmission and reception of signals by the computing device in the process 700 may be enabled, for example, by one or more antennas and/or one or more transceivers (e.g., wireless transceiver(s)).

At block 702, the computing device (or component thereof) can receive a master information block (MIB) from a network device (e.g., a base station or a portion of a base station, such as a central unit (CU), a distributed unit (DU), a radio unit (RU), a Near-Real Time (Near-RT) RAN Intelligent Controller (RIC), or a Non-Real Time (Non-RT) RIC of a disaggregated base station). In some aspects, the MIB is received by the computing device (or component thereof) from the network device via a physical broadcast channel (PBCH).

At block 704, the computing device (or component thereof) can determine, based on decoding the MIB, a cell type associated with the network device. The cell type is a non-public network (NPN) cell or a non-NPN cell.

In some aspects, the computing device (or component thereof) can receive, from the network device, a system information block type one (SIB1). In some cases, the SIB1 is received by the computing device (or component thereof) from the network device via a physical downlink shared channel (PDSCH). In some aspects, the computing device (or component thereof) can decode the SIB1.

In some cases, based on the cell type being an NPN cell and the computing device being an NPN user equipment (UE), the computing device (or component thereof) can decode the SIB1 by descrambling the SIB1 based on a system information-radio network temporary identifier (SI-RNTI) and a public network integrated NPN (PNI-NPN) identification or based on the SI-RNTI and a standalone non-public network (SNPN) identification. In some aspects, a non-public network identification (NPN ID) associated with the computing device includes the PNI-NPN identification and the SNPN identification. In some cases, a subscriber identity module (SIM) of the computing device includes the NPN ID.

In some aspects, based on the cell type being a non-NPN cell, the computing device (or component thereof) can decode the SIB1 by descrambling the SIB1 based on a system information-radio network temporary identifier (SI-RNTI).

In some aspects, the computing device (or component thereof) can not decode (or determine not to decode) the SIB1 based on the cell type being an NPN cell and based on the computing device being a non-NPN user equipment (UE).

In some cases, the computing device of process 700 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 700 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed to secure broadcast information for NPNs. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LiDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for wireless communications, the apparatus comprising: at least one memory; and at least one processor coupled to the at least one memory and configured to: receive, from a network device, a master information block (MIB); and determine, based on decoding the MIB, a cell type associated with the network device, wherein the cell type is a non-public network (NPN) cell or a non-NPN cell.

Aspect 2. The apparatus of Aspect 1, wherein the at least one processor is configured to receive, from the network device, a system information block type one (SIB1).

Aspect 3. The apparatus of Aspect 2, wherein the SIB1 is received via a physical downlink shared channel (PDSCH) transmitted from the network device.

Aspect 4. The apparatus of any of Aspects 2 or 3, wherein the at least one processor is configured to decode the SIB1.

Aspect 5. The apparatus of Aspect 4, wherein, to decode the SIB1, the at least one processor is configured to descramble, based on the cell type being an NPN cell and the apparatus being an NPN user equipment (UE), the SIB1 based on a system information-radio network temporary identifier (SI-RNTI) and a public network integrated NPN (PNI-NPN) identification or based on the SI-RNTI and a standalone non-public network (SNPN) identification.

Aspect 6. The apparatus of Aspect 5, wherein a non-public network identification (NPN ID) associated with the apparatus comprises the PNI-NPN identification and the SNPN identification.

Aspect 7. The apparatus of Aspect 6, wherein a subscriber identity module (SIM) of the apparatus comprises the NPN ID.

Aspect 8. The apparatus of any of Aspects 4 to 7, wherein, to decode the SIB1, the at least one processor is configured to descramble, based on the cell type being a non-NPN cell, the SIB1 based on a system information-radio network temporary identifier (SI-RNTI).

Aspect 9. The apparatus of any of Aspects 2 to 8, wherein the at least one processor is configured to not decode the SIB1 based on the cell type being an NPN cell and based on the apparatus being a non-NPN user equipment (UE).

Aspect 10. The apparatus of any of Aspects 1 to 9, wherein the MIB is received via a physical broadcast channel (PBCH) transmitted from the network device.

Aspect 11. The apparatus of any of Aspects 1 to 10, wherein the apparatus is user equipment (UE).

Aspect 12. The apparatus of any of Aspects 1 to 11, wherein the network device is a base station.

Aspect 13. A method for wireless communications at a computing device, the method comprising: receiving, from a network device, a master information block (MIB); and determining, based on decoding the MIB, a cell type associated with the network device, wherein the cell type is a non-public network (NPN) cell or a non-NPN cell.

Aspect 14. The method of Aspect 13, further comprising receiving, from the network device, a system information block type one (SIB1).

Aspect 15. The method of Aspect 14, wherein the SIB1 is received via a physical downlink shared channel (PDSCH) transmitted from the network device.

Aspect 16. The method of any of Aspects 14 or 15, further comprising decoding the SIB1.

Aspect 17. The method of Aspect 16, wherein decoding the SIB1 comprises, based on the cell type being an NPN cell and the computing device being an NPN user equipment (UE), descrambling the SIB1 based on a system information-radio network temporary identifier (SI-RNTI) and a public network integrated NPN (PNI-NPN) identification or based on the SI-RNTI and a standalone non-public network (SNPN) identification.

Aspect 18. The method of Aspect 17, wherein a non-public network identification (NPN ID) associated with the computing device comprises the PNI-NPN identification and the SNPN identification.

Aspect 19. The method of Aspect 18, wherein a subscriber identity module (SIM) of the computing device comprises the NPN ID.

Aspect 20. The method of any of Aspects 16 to 19, wherein decoding the SIB1 comprises, based on the cell type being a non-NPN cell, descrambling the SIB1 based on a system information-radio network temporary identifier (SI-RNTI).

Aspect 21. The method of any of Aspects 14 to 20, further comprising not decoding, based on the cell type being an NPN cell and based on the computing device being a non-NPN user equipment (UE), the SIB1.

Aspect 22. The method of any of Aspects 13 to 21, wherein the MIB is received via a physical broadcast channel (PBCH) transmitted from the network device.

Aspect 23. The method of any of Aspects 13 to 22, wherein the computing device is user equipment (UE).

Aspect 24. The method of any of Aspects 13 to 23, wherein the network device is a base station.

Aspect 25. A non-transitory computer-readable medium having stored thereon instructions that, when executed by at least one processor, cause the at least one processor to perform operations according to any of Aspects 13 to 24.

Aspect 26. An apparatus for wireless communications, the apparatus including one or more means for performing operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
at least one memory; and
at least one processor coupled to the at least one memory and configured to:
receive, from a network device, a master information block (MIB); and
determine, based on decoding the MIB, a cell type associated with the network device, wherein the cell type is a non-public network (NPN) cell or a non-NPN cell.

2. The apparatus of claim 1, wherein the at least one processor is configured to receive, from the network device, a system information block type one (SIB1).

3. The apparatus of claim 2, wherein the SIB1 is received via a physical downlink shared channel (PDSCH) transmitted from the network device.

4. The apparatus of claim 2, wherein the at least one processor is configured to decode the SIB1.

5. The apparatus of claim 4, wherein, to decode the SIB1, the at least one processor is configured to descramble, based on the cell type being an NPN cell and the apparatus being an NPN user equipment (UE), the SIB1 based on a system information-radio network temporary identifier (SI-RNTI) and a public network integrated NPN (PNI-NPN) identification or based on the SI-RNTI and a standalone non-public network (SNPN) identification.

6. The apparatus of claim 5, wherein a non-public network identification (NPN ID) associated with the apparatus comprises the PNI-NPN identification and the SNPN identification.

7. The apparatus of claim 6, wherein a subscriber identity module (SIM) of the apparatus comprises the NPN ID.

8. The apparatus of claim 4, wherein, to decode the SIB1, the at least one processor is configured to descramble, based on the cell type being a non-NPN cell, the SIB1 based on a system information-radio network temporary identifier (SI-RNTI).

9. The apparatus of claim 2, wherein the at least one processor is configured to not decode the SIB1 based on the cell type being an NPN cell and based on the apparatus being a non-NPN user equipment (UE).

10. The apparatus of claim 1, wherein the MIB is received via a physical broadcast channel (PBCH) transmitted from the network device.

11. The apparatus of claim 1, wherein the apparatus is user equipment (UE).

12. The apparatus of claim 1, wherein the network device is a base station.

13. A method for wireless communications at a computing device, the method comprising:
receiving, from a network device, a master information block (MIB); and
determining, based on decoding the MIB, a cell type associated with the network device, wherein the cell type is a non-public network (NPN) cell or a non-NPN cell.

14. The method of claim 13, further comprising receiving, from the network device, a system information block type one (SIB1).

15. The method of claim 14, wherein the SIB1 is received via a physical downlink shared channel (PDSCH) transmitted from the network device.

16. The method of claim 14, further comprising decoding the SIB1.

17. The method of claim 16, wherein decoding the SIB1 comprises, based on the cell type being an NPN cell and the computing device being an NPN user equipment (UE), descrambling the SIB1 based on a system information-radio network temporary identifier (SI-RNTI) and a public network integrated NPN (PNI-NPN) identification or based on the SI-RNTI and a standalone non-public network (SNPN) identification.

18. The method of claim 17, wherein a non-public network identification (NPN ID) associated with the computing device comprises the PNI-NPN identification and the SNPN identification.

19. The method of claim 16, wherein decoding the SIB1 comprises, based on the cell type being a non-NPN cell, descrambling the SIB1 based on a system information-radio network temporary identifier (SI-RNTI).

20. The method of claim 14, further comprising not decoding, based on the cell type being an NPN cell and based on the computing device being a non-NPN user equipment (UE), the SIB1.
